(19) United States
(12) Patent Application Publication
(10) Pub. No.: US 2007/0250262 A1
(43) Pub. Date: Oct. 25, 2007

(54) Device, method and medium detecting errors generated by distortion in a magnetic field

(75) Inventors: Woo-jong Lee, Suwon-si (KR); Kyung-il Cho, Songpa-gu (KR); Sang-on Choi, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/703,799

(22) Filed: Feb. 8, 2007

(30) Foreign Application Priority Data
Apr. 19, 2006 (KR) 10-2006-035241

(51) Int. Cl. G01C 21/20

(52) U.S. Cl. 701/207

(57) ABSTRACT

A method, medium and electronic device using a three-axis geomagnetic sensor for quick and accurate measurement of an azimuth angle includes a first calculating unit to calculate distances between an output value of the three-axis geomagnetic sensor and an offset value, and a controller to determine that the offset value is distorted when the distance calculated by the first calculating unit deviates from a predetermined range of radius values. The electronic device can further include a sampling unit to sample output values of the three-axis geomagnetic sensor when the calculated distance deviates from the predetermined range of radius values, and a second calculating unit to calculate a mean value and a standard deviation value for distances between the sampled values and the offset value. The controller may determines that the offset value is distorted when the mean value and the standard deviation value deviate from predetermined permissible ranges.

### CROSS-REFERENCE TO RELATED APPLICATIONS

This application claims the benefit under 35 U.S.C. § 119(a) of Korean Patent Application No. 10-2006-035241, filed Apr. 19, 2006, in the Korean Intellectual Property Office, the entire disclosure of which is incorporated herein by reference.

### BACKGROUND OF THE INVENTION

1. Field of the Invention

An embodiment of the present invention relates generally to an electronic device method, medium to detect whether there is an error generated as a result of a distortion in a magnetic field environment. More particularly, an embodiment of the present invention relates to an electronic device method, and medium to determine whether an offset value is distorted using a distance between an output value of a geomagnetic sensor and an offset value, thereby checking for an error.

2. Description of the Related Art

Recently, electronic devices having a global positioning system (GPS) capability, a compass capability, or similar directional capabilities have become commonly available. To carry out such capabilities, the electronic device must produce an azimuth angle. Generally, to produce the azimuth angle, a gyro sensor or a geomagnetic sensor is used.

The gyro sensor is a device, which measures a coriolis force to detect an angular velocity of rotation. With a gyro sensor, after an angular velocity is measured, the angular velocity is integrated to calculate angular displacement information. In this case, there is a problem, in that errors may be generated due to accumulated integral constants generated as a result of multiple integrations. In addition, since the gyro sensor has a relatively large size as compared with a geomagnetic sensor, it is difficult to use the gyro sensor in a portable electronic device.

The geomagnetic sensor is a sensor which measures a voltage induced by a geomagnetism using flux-gates. The geomagnetic sensor can be embodied in two axes or three axes. In this case, geomagnetic output values produced from the two-axis or three-axis geomagnetic sensor vary according to the magnitude of a peripheral magnetic field. Typically, a normalization is accomplished by mapping the geomagnetic output values in a predetermined range (for example, from −1 through 1). The normalization is carried out using normalization factors, such as a scale value or an offset value. To calculate the normalization factors, it is necessary that the output values are produced from the geomagnetic sensor while it rotates several times, and a maximum value and a minimum value are detected among the output values. The values normalized using the normalization factors are used for an azimuth angle correcting operation.

Among the normalization factors as described above, the offset value may be distorted by the peripheral environment. That is, if the geomagnetic sensor is built into a portable electronic device, such as a mobile phone, the offset value can vary when a battery is changed or cover with a liquid crystal display (LCD) is opened and closed. In addition, if an obstructive substance, such as a ferromagnetic body or an iron bar structure is near the electronic device, the offset value can vary. Accordingly, in this case, if the normalization process is carried out using the distorted offset value, the normalized resultant value is distorted. As a result, the finally calculated azimuth angle may include errors caused by the distortion.

Thus, in such conventional electronic devices using a geomagnetic sensor, it is difficult for a user to determine whether the finally calculated azimuth angle is correct or includes errors. In addition, even though there is something wrong with the azimuth angle, it is difficult to determine whether the errors are caused by the distortion of the offset value or whether the geomagnetic sensor is out of order, and thus difficult to easily determine whether the distortion of the offset value should be corrected. In addition, even though the distortion of the offset value is corrected, the user cannot be confident that the corrected value is the right value.

### SUMMARY OF THE INVENTION

An aspect of one or more embodiments of the present invention is to solve at least the above problems and/or disadvantages and to provide at least the advantages described below. Accordingly, an aspect of one or more embodiments of the present invention is to provide an electronic device, method, and medium to confirm a distance between a geomagnetic output value and an offset value to determine whether the offset value is distorted, thereby checking an error.

Another aspect of an embodiment of the present invention is to provide an electronic device, method, and medium, which when it is determined that an offset value is distorted, samples a plurality of geomagnetic output values, and secondly determines whether the offset value is distorted using the sampled geomagnetic output values, thereby checking errors.

Still another aspect of an embodiment of the present invention is to provide an electronic device, method, and medium that, when it is determined that an offset value is distorted, corrects the offset value thereof.

Also another aspect of an embodiment of the present invention is to provide an electronic device, method, and medium that when an offset value is corrected after it is determined that the offset value distorted, determines whether the corrected offset value is a right value.

Additional aspects and/or advantages of the invention will be set forth in part in the description which follows and, in part, will be apparent from the description, or may be learned by practice of the invention.

According to an aspect of still another embodiment of the present invention, there is provided an electronic device including a three-axis geomagnetic sensor, a first calculating unit to calculate a distance between a geomagnetic output value generated by the three-axis geomagnetic sensor and an offset value, and a controller to determine that the offset value is distorted when the distance calculated by the first calculating unit deviates from a predetermined range of radius values.

The electronic device may further include a sampling unit to sample geomagnetic output values output from the three-axis geomagnetic sensor when the calculated distance deviates from the predetermined range of radius values, and a second calculating unit to calculate a mean value and a standard deviation value to distances between the plurality of sampled values output from the sampling unit and the offset value. In this case, the controller may finally determine that the offset value is distorted when the mean value and the standard deviation value calculated by the second calculating unit deviate from predetermined permissible ranges, respectively.

The electronic device may further include a correcting unit to correct the offset value when the controller determined that offset value is distorted.

At this time, the correcting unit may correct the offset value by applying a least square fitting method of using the plurality of sampled values.

When the offset value is corrected by the correcting unit, the controller may control the first and the second calculating units to calculate a mean value and a standard deviation value to distances between the plurality of sampled values and the corrected offset value, and then compares the calculated mean value and the calculated standard deviation value with the predetermined permissible ranges, respectively, to determine whether the corrected offset value is distorted.

The electronic device may further include a displaying unit to display a message that indicates that the offset value is distorted, when the control unit determines that the offset value is distorted.

When one geomagnetic output value is sampled from the three-axis geomagnetic sensor, the sampling unit may confirm a distance of the sampled one geomagnetic output value to the previously sampled geomagnetic output values, and select the sampled one geomagnetic output value as a sampling value only when the confirmed distance is above a predetermined distance.

The electronic device may further include a first storing unit to store information on the offset value, the predetermined range of radius values, and the predetermined permissible ranges to the mean value and the standard deviation value, and a second storing unit to store the plurality of sampled values sampled by the sampling unit.

The distances, the mean value and the standard deviation value may be calculated using the following equations, respectively:

$$r ( i ) = \sqrt{{( {X}_{i} - Xo )}^{2} + {( {Y}_{i} - Yo )}^{2} + {( {Z}_{i} - Zo )}^{2}}$$

$$Mean = {\sum }_{i = 1}^{N} \frac{r ( i )}{N}$$

$$SD = {\sum }_{i = 1}^{N} \frac{{( r ( i ) - Mean )}^{2}}{N}$$

wherein (Xo, Yo, Zo) is a three-axis coordinate value of the offset value, (Xᵢ, Yᵢ, Zᵢ) is a three-axis coordinate value of an output value output at the i-th place from the three-axis geomagnetic sensor, r(i) is a distance between the i-th three-axis output value and the offset value, Mean is the mean value, SD is the standard deviation value, i is a natural number and N is a number of samplings.

The three-axis geomagnetic sensor may include X, Y and Z-axis flux-gates disposed orthogonally, a driving signal producing unit to provide driving signals to the X, Y and Z-axis flux-gates, a signal processing unit to operate, so that when the X, Y and Z-axis flux-gates are driven by the driving signals to output electric signals corresponding to a peripheral magnetism, the signal processing unit converts the output electric signals into digital values and outputs the converted digital values, and a geomagnetic sensor control unit to carry out a normalization operation to map the output digital values from the signal processing unit into values within a predetermined magnitude by using the corrected offset value and a predetermined scale value and to output respective normalized three-axis output values.

The electronic device may further include an inclined angle calculating unit to calculate a pitch angle and a roll angle of the electronic device. In this case, the controller may calculate an azimuth angle using the normalized three-axis output values, the pitch angle and the roll angle when the three-axis output values normalized by the corrected offset value and the predetermined scale value is provided from the geomagnetic sensor control unit.

According to another aspect of an embodiment of the present invention, there is provided an error check method of an electronic device using a three-axis geomagnetic sensor. The error check method includes calculating a distance between a geomagnetic output value output from the three-axis geomagnetic sensor and an offset value, and determining that the offset value is distorted when the calculated distance deviates from a predetermined range of radius values.

The method may further include sampling a plurality of values among the geomagnetic output values output from the three-axis geomagnetic sensor when the calculated distance deviates from the predetermined range of radius values, calculating a mean value and a standard deviation value to distances between the plurality of sampled values and the offset value, and finally determining that the offset value is distorted when the calculated mean value and the calculated standard deviation value deviate from predetermined permissible ranges, respectively.

The method may further include correcting the offset value when the offset value is determined as distorted.

In this case, the correcting the offset value may include correcting the offset value by applying a least square fitting method of using the plurality of sampled values.

Also, the method may further include recalculating a mean value and a standard deviation value to distances between the plurality of sampled values and the corrected offset value, comparing the recalculated mean value and the recalculated standard deviation value with the predetermined permissible ranges, respectively, to determine whether the corrected offset value is distorted, and repeatedly carrying out the operations from the calculating the distance through the finally determining that the offset value is distorted, when the corrected offset value is determined as distorted.

The method may further include displaying a message, which informs that the offset value is distorted, when the offset value is determined as distorted.

The sampling the plurality of values may include confirming a distance of one geomagnetic output value to the geomagnetic output values sampled in advance when the one geomagnetic output value is sampled from the three-axis geomagnetic sensor, and selecting the sampled one geomagnetic output value as a sampling value only when the confirmed distance is above a predetermined distance.

The distances, the mean value and the standard deviation value are calculated using the following equations, respectively:

$$r ( i ) = \sqrt{{( {X}_{i} - Xo )}^{2} + {( {Y}_{i} - Yo )}^{2} + {( {Z}_{i} - Zo )}^{2}}$$

$$Mean = {\sum }_{i = 1}^{N} \frac{r ( i )}{N}$$

$$SD = {\sum }_{i = 1}^{N} \frac{{( r ( i ) - Mean )}^{2}}{N}$$

wherein (Xo, Yo, Zo) is a three-axis coordinate value of the offset value, (Xᵢ, Yᵢ, Zᵢ) is a three-axis coordinate value of an output value output at the i-th place from the three-axis geomagnetic sensor, r(i) is a distance between the i-th three-axis output value and the offset value, Mean is the mean value, SD is the standard deviation value, i is a natural number and N is the number of sampling.

The sampling the plurality of values may include terminating the sampling when a situation where the distance between the geomagnetic output value and the offset value calculated during the sampling is within the predetermined range of radius values occurs more than predetermined number.

According to yet another aspect of an exemplary embodiment of the present invention there is provided at least one medium having computer readable code to control at least one processing element to implement an error check method of an electronic device using a three-axis geomagnetic sensor. The method includes calculating a distance between a geomagnetic output value output from the three-axis geomagnetic sensor and an offset value, and determining that the offset value is distorted when the calculated distance deviates from a predetermined range of radius values.

### BRIEF DESCRIPTION OF THE DRAWINGS

These and other aspects and advantages of one or more embodiments of the present invention will become more apparent from the following description of embodiments, taken in conjunction with the accompanying drawings, wherein;

FIGS. 1 through 4 illustrate electronic devices according to various embodiments of the present invention;

FIG. 5 illustrates a three-axis geomagnetic sensor, can be used in the electronic devices according to the various embodiments of the present invention;

FIG. 6 illustrates an orientation of the three-axis geomagnetic sensor, which can be used to the electronic devices according to the various exemplary embodiments of the present invention;

FIG. 7 illustrates a spherical coordinate system in which output values of the three-axis geomagnetic sensor, distorted under the influence of peripheral magnetism, and an offset value corrected using the output values; and

FIGS. 8 through 10 illustrate error check methods according to various embodiments of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

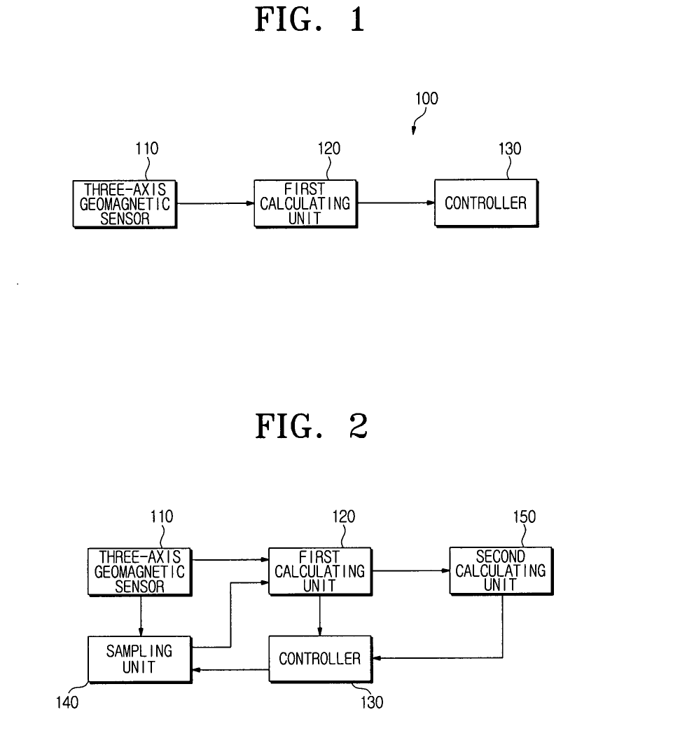

FIG. 1 illustrates an electronic device, according to an embodiment of the present invention.

Referring to FIG. 1, the electronic device 100 may include a three-axis geomagnetic sensor 110, a first calculating unit 120, and a controller 130, for example. The electronic device 100 can be embodied as an electronic compass, a mobile phone, a GPS apparatus for vehicle, a notebook PC or as any portable electronic device, also as only an example.

The three-axis geomagnetic sensor 110 produces an output value corresponding to a peripheral magnetism by using X, Y and Z-axis flux-gates, which are disposed in directions perpendicular to one another. The output value output from the three-axis geomagnetic sensor 110 may be a value in which output values of the X, Y and Z-axis flux-gates are mapped and normalized in a predetermined range, for example, from −1 through 1, respectively. In this case, an offset value and a scale value, which are used in the normalization process, may be predetermined and stored in an internal memory (not illustrated).

The first calculating unit 120 calculates a distance between the output value output from the three-axis geomagnetic sensor 110 and the offset value. The distance between the output value output from the three-axis geomagnetic sensor 110 and the offset value corresponds to a straight line distance on a three-dimensional spherical coordinate system. That is, the output value output from the three-axis geomagnetic sensor 110 is represented as a three-axis coordinate value (X, Y, Z). Also, the offset value is represented as a three-axis coordinate value including X, Y and Z-axis components. Accordingly, the distance between the output value of the three-axis geomagnetic sensor 110 and the offset value can be calculated using the following mathematic equation 1.

Equation 1, for example

r=\sqrt{(X−Xo)²+(Y−Yo)²+(Z−Zo)²}

Here, r is the distance between the output value of the three-axis geomagnetic sensor 110 and the offset value, (X, Y, Z) is a three-axis coordinate value of the output value of the three-axis geomagnetic sensor 110, and (Xo, Yo, Zo) is a three-axis coordinate value of the offset value.

The controller 130 compares the distance calculated by the first calculating unit 120 with a predetermined permissible range to determine whether the offset value is distorted. That is, if the calculated distance deviates from the predetermined permissible range, the controller 130 determines that the offset value is distorted, and if the calculated distance is within the predetermined permissible range, the offset value may be determined normal. For example, under the state that the permissible range is set as 1±0.2, if the calculated distance is 1.5, the controller 130 determines that the presently set offset value is distorted. The permissible range can be set as various values (for example, 1, 1±0.2, etc.) according to a field, an object and the like for using the electronic machine. The set permissible range can be stored in an internal memory (not illustrated) or an external memory (not illustrated) disposed inside or separately from the controller 130, and provided to the controller 130 at the request of the controller 130.

Here, the electronic device can quickly determine whether the offset value is distorted.

FIG. 2 illustrates an electronic device, according to another embodiment of the present invention. In FIG. 2, the same elements as those of the electronic device of FIG. 1 are designated with the same drawing reference numerals, and may not be discussed in great detail hereafter. Referring to FIG. 2, the electronic device may include a three-axis geomagnetic sensor 110, a first calculating unit 120, a controller 130, a sampling unit 140, and a second calculating unit 150. Among operations of the three-axis geomagnetic sensor 110 and the first calculating unit 120, descriptions of the same operations as those of the three-axis geomagnetic sensor 110 and the first calculating unit 120 of the electronic device 100 of FIG. 1 will be omitted for clarity and conciseness.

When the controller 130 determines that the offset value is distorted, through the distance calculated by the first calculating unit 120, it may control the sampling unit 140 to sample a plurality of values among output values of the three-axis geomagnetic sensor 110.

Thus, the sampling unit 140 may sample the output values from the three-axis geomagnetic sensor 110 several times, and output the sampled values. At this time, preferably, but not necessarily, the sampling unit 140 may complete the sampling process within a predetermined time. That is, if the predetermined time has lapsed after a first sampling, the sampling unit 140 may annul a value sampled in the first sampling and newly carry out a first sampling. Here, a user or a manufacturer of the electronic device can freely determine the quantity of samplings.

Also, preferably, but not necessarily, to accurately detect whether the offset value is distorted, the sampling unit 140 may sample, so that each of the distances between the sampled values come to be above a predetermined distance. That is, assuming that a value sampled at the i-th place (i being a natural number) is Si, when S2 is sampled, the sampling unit 140 may calculate a distance between S1 and S2, and compares the calculated distance with a predetermined critical distance. And then, if the calculated distance is within the range of the predetermined critical distance, the sampling unit 140 newly samples S2, and if beyond the range of the predetermined critical distance, it selects S2 and samples S3. When S3 is sampled, the sampling unit 140 calculates a distance between S1 and S3 and a distance between S2 and S3 in turn, and compares each of the calculated distances with the predetermined critical distance. If either one of or both calculated distances is within the range of the predetermined critical distance, the sampling unit 140 newly samples S3, and if both calculated distances are beyond the range of the predetermined critical distance, it selects S3 and samples S4. In this manner, the sampling unit 140 samples values S1˜SN for the number of samplings (referred as N below), e.g., set by the user, and outputs the values S1˜SN.

In this case, the distances between the sampled values may be calculated by the first calculating unit 120. That is, whenever the sampling unit 140 samples a value and provides the sampled value to the first calculating unit 120, the first calculating unit 120 may calculate a distance between the previously sampled value and the newly sampled value, and output the calculated distance to the controller 130. Accordingly, the controller 130 can determine whether a value should be newly sampled or a next sampling should be carried out, on the basis of the calculated distance, and then control the sampling unit 140 to carry out the corresponding sampling operation.

Further, the first calculating unit 120 may calculate a distance between each of the sampled values S1˜SN output from the sampling unit 140 and the predetermined offset value. In this case, the first calculating unit 120 can calculate the distance between each of the sampled values and the predetermined offset value after all samplings are complete, or calculate the distance between the sampled value and the predetermined offset value whenever each sampling is carried out, and then output the calculated distances to the controller 130. At this time, the controller 130 can terminate the sampling process if it is determined that the calculated distance is within a predetermined range of radius values.

The second calculating unit 150 may calculate a mean value and a standard deviation value, for example, for the distances between the sampled values and the predetermined offset value. The mean value and the standard deviation value can be calculated using the following mathematic equation 2, for example.

$$\text{Equation 2:} \\ Mean = {\sum }_{i = 1}^{N} \frac{r ( i )}{N} \\ SD = {\sum }_{i = 1}^{N} \frac{{( r ( i ) - Mean )}^{2}}{N} \qquad$$

Here, r(1) is a distance between a three-axis output value of a value sampled at the i-th place and the offset value, Mean is the mean value, SD is the standard deviation value.

The mean value and the standard deviation value calculated by the second calculating unit 150 may further be provided to the controller 130.

accordingly, the controller 130 compares the mean value and the standard deviation value with predetermined permissible ranges, respectively, and ultimately determines whether the offset value is distorted. For example, if both the mean value and the standard deviation value are within the predetermined permissible ranges, the controller 130 may determine that the offset value is normal, and if either one of or both the mean value and the standard deviation value exceeds the predetermined permissible range, it may determine that the offset value is distorted. Here, the electronic device may determine in two steps, using a first and a second controller, whether the offset value is distorted for enhanced accuracy.

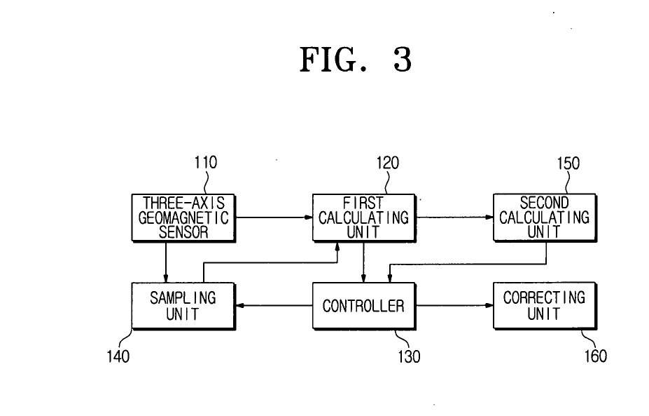

FIG. 3 illustrates an electronic device, according to still another embodiment of the present invention. Referring to FIG. 3, the electronic device may include a three-axis geomagnetic sensor 110, a first calculating unit 120, a controller 130, a sampling unit 140, a second calculating unit 150, and a correcting unit 160, for example. Among operations of the three-axis geomagnetic sensor 110, the first calculating unit 120, the controller 130, the sampling unit 140, and the second calculating unit 150, descriptions of the same operations as those already described in FIGS. 1 and 2 for the three-axis geomagnetic sensor 110, the first calculating unit 120 the controller 130, the sampling unit 140, and the second calculating unit 150 of the electronic device will be omitted for clarity and conciseness.

Referring to FIG. 3, when the controller 130 makes a two-step determination that the offset value is distorted, the controller 130 may further control the correcting unit 160 to directly correct the offset value. In this case, the offset value correction can be carried out by various methods.

For example, to correct the offset value, a least square fitting method may be applicable. An example of such a least square fitting method is discussed in greater detail in “An algorithm for fitting of spheres” by Ik-Sung Kim, J. Korea Soc. Math. Educ. Ser. B, Pure Appl. Math. Volume 11, Number 1. See pages 37-49. (February 2004).

Hereinafter, an example of an operation which corrects the offset value by applying such a least square fitting method will be briefly described.

First, the correcting unit 160 may estimate an offset correcting factor in a random value. The offset correcting factor, as a factor for correcting the offset value, is a shape, which includes X, Y and Z-axis components. And then, the correcting unit 160 may calculate equations 3 through 5, in turn, using the plurality of sampled values sampled by the sampling unit 140, for example.

$$\text{Equation 3:} \\ {a}_{i} = \frac{{X}_{i} - X 0}{r 1} , {b}_{i} = \frac{{Y}_{i} - Y 0}{r 2} , {c}_{i} = \frac{{Z}_{i} - Z 0}{r 3} \qquad$$

Here, r1, r2, and r3 are predetermined X, Y, and Z-axis scale values, respectively, and X0, Y0 and Z0 are predetermined X, Y, and Z-axis offset values, respectively.

fakᵢ=\sqrt{aᵢ²+bᵢ²+cᵢ²} Equation 4

fᵢ=\sqrt{(X0−Xᵢ)²+(Y0−Yᵢ)²+(Z0−Zᵢ)²}−r0 Equation 5

Here, r0 is a radius value of a magnetic sphere centering on the predetermined offset value, and Xᵢ, Yᵢ and Zᵢ are X, Y, and Z-axis geomagnetic output values sampled at the I-th place, respectively.

The correcting unit 160 may calculate a jacobian matrix, which is represented as the following mathematic formula 6, using the resultant values of the mathematic formulas 3 through 5, for example.

$$\text{Equation 6:} \\ {J}_{i} = [ \frac{{a}_{i}}{{fak}_{i}} , \frac{{b}_{i}}{{fak}_{i}} , \frac{{c}_{i}}{{fak}_{i}} ] \qquad$$

The number of lines in the jacobian matrix according to the equation 6 is the same as the aforementioned number of samplings N. For example, if the sampling is carried out four times, jᵢ of the mathematic equation 6 is represented as 4×3 matrix. In this case, a transpose jacobian matrix is represented as 3×4 matrix.

The correcting unit 160 may then substitute the resultant values of equations 3 through 6 for the following equation formula 7, for example, to correct the offset correcting factor and the offset value, respectively. Equation 7:

h=[Jᵢ^{T}*Jᵢ]⁻¹*[Jᵢ^{T}(−fᵢ)]

Uₙ=u+h Equation 7

Here, Jᵢ is the jacobian matrix, Jᵢ^{T} is the transposed jacobian matrix, h is a corrected offset correcting factor, uₙ is a corrected offset value, and u is a pre-corrected offset value.

The correcting unit 160 may compare a critical value corresponding to the corrected offset value with the corrected offset correcting factor. As described above, both the offset correcting factor and the offset value include X, Y and Z-axis components. Also, the critical value can be set as a value, which is obtained by squaring each of the axis components of the corrected offset value, adding the squared values, and multiplying a square root of the added resultant value by a fixed constant β. The correcting unit 160 adds values, which have squared each of the X, Y and Z-axis components of the offset correcting factor, calculates a square root of the added resultant value, and then compares the calculated value with the critical value described above. The comparing formula may be represented by the following equation 8, for example. Equation 8:

\sqrt{Xh²Yh²+Zh²}<β*\sqrt{Xn²Yn²+Zn²} Equation 8

Here, Xh, Yh, and Zh are three-axis coordinate values of the corrected offset correcting factor, respectively, and Xn, Yn, and Zn are three-axis coordinate values of the corrected offset value, respectively. In equation 8, the fixed constant β can be set as a random value. For example, the fixed constant β can be set as 10⁻⁶.

As a result of the comparison in the equation 8, if the value of the corrected offset correcting factor is less than the critical value, the correcting unit 160 completes the correcting operation. To the contrary, if the value of the corrected offset correcting factor exceeds the critical value, the correcting unit 160 repeatedly carries out the correcting operation, which uses the above equations 3 through 7 as the basis of the corrected offset correcting factor and the corrected offset value.

The offset value can be corrected by methods other than the least square fitting method as described above. For example, the offset value can be corrected in a manner that X, Y and Z-axis output values are obtained while a user directly rotates the electronic device several times in various directions, a maximum value and a minimum values are detected among the X, Y and Z-axis output values, and then an offset value is newly calculated by using the maximum value and the minimum values. Alternative embodiments are equally available.

The controller 130 may also determine whether even the offset value corrected by the correcting unit 160 is distorted. To be more specific, the controller 130 may control the first calculating unit 120 and the second calculating unit 150 to calculate a mean value and a standard deviation value for distances between the corrected offset value and the plurality of the sampled values previously sampled. Then, the controller 130 may determine whether the calculated mean value and the calculated standard deviation value are within the permissible ranges, respectively. As a result of the determination, if the calculated mean value and the calculated standard deviation value are within the permissible ranges, the controller 130 may recognize that the offset value is normal, and if they deviate from the permissible ranges, control corresponding units to newly determine whether the offset value is distorted, and to carry out the correcting operation for correcting the offset value.

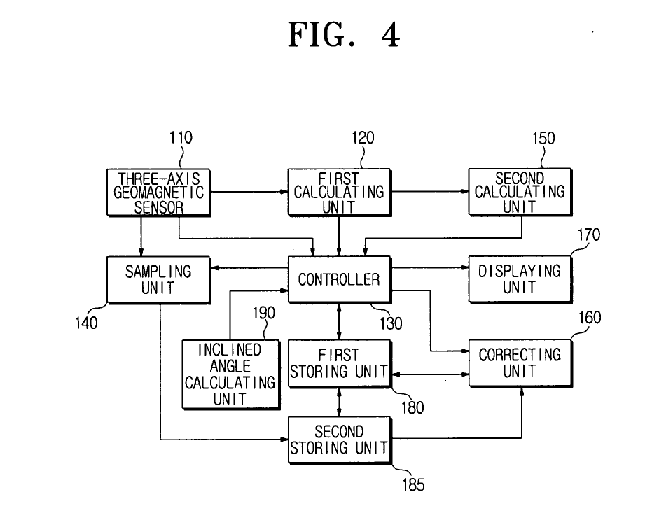

FIG. 4 illustrates an electronic device according to a still further embodiment of the present invention. Referring to FIG. 4, the electronic device may include a three-axis geomagnetic sensor 110, a first calculating unit 120, a controller 130, a sampling unit 140, a second calculating unit 150, a correcting unit 160, a displaying unit 170, a first storing unit 180, a second storing unit 185, and an inclined angle calculating unit 190, for example. Descriptions for those elements in FIG. 4 carrying out operations similar to those of the electronic devices illustrated in FIGS. 1 through 3 have been omitted for clarity and conciseness.

In FIG. 4, the first storing unit 180, as a memory device disposed separately from the controller 130, may store a predetermined offset value, a predetermined range of radius values, permissible ranges, etc. In an embodiment, the first storing unit 180 may be embodied in a read only memory (ROM).

If the predetermined offset value is corrected, the first storing unit 180 may update the corrected offset value as a new offset value.

The second storing unit 185, as a memory device disposed separately from the sampling unit 140, may store values, which are sampled by the sampling unit 140. Similar to above, in an embodiment, the second storing unit 189 may be embodied in a random access memory (RAM).

The three-axis geomagnetic sensor 110 may output three-axis geomagnetic output values, which are normalized using corrected offset value.

The inclined angle calculating unit 190, thus, calculates a degree that the electronic device is inclined, i.e. a pitch angle and a roll angle.

The controller 130 may then calculate an azimuth angle using the three-axis geomagnetic output values output from the three-axis geomagnetic sensor 110 and the pitch angle and the roll angle calculated by the inclined angle calculating unit 190. The calculation of the azimuth angle can be carried out using equation 9, for example.

$$\text{Equation 9:} \\ Ψ = {tan}^{- 1} ( \frac{{Y}_{norm} * cos φ - {Z}_{norm} * sin φ}{{X}_{norm} * cos θ - {Y}_{norm} * sin θ * sin φ - {Z}_{norm} * sin θ * cos φ} ) \qquad$$

Here, Ψ is the azimuth angle, Xₙₒᵣₘ, Yₙₒᵣₘ, and Zₙₒᵣₘ are the three-axis geomagnetic output values normalized using the corrected offset value, respectively, θ is the pitch angle, and Φ is the roll angle.

The controller 130 may calculate the azimuth angle using the values normalized according to the offset value in which the distortion is corrected, so that the azimuth angle can be accurately calculated.

Similar to above, two-step determination is made to ascertain whether the offset value is distorted if it is determined that the offset value is distorted, the controller 130 can inform the user through the displaying unit 170, for example, that the offset value is distorted, while correcting the offset value through the correcting unit 160. In this case, the displaying unit 170 can be embodied in a liquid crystal display (LCD) screen or a light emitting diode (LED), although other types of displays can equally be used.

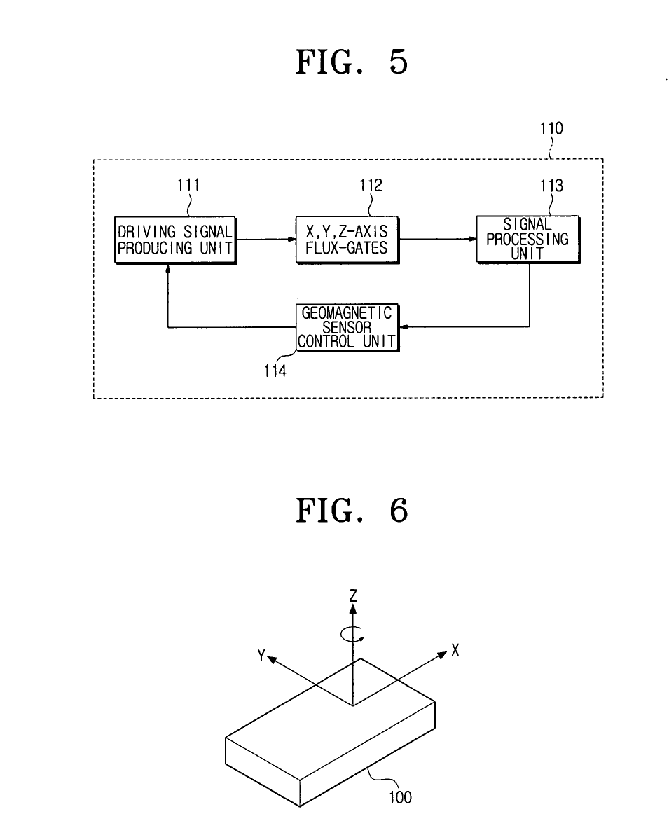

FIG. 5 illustrates an example of a three-axis geomagnetic sensor 110, which may be used in the electronic devices of FIGS. 1 through 4, for example. Referring to FIG. 5, the three-axis geomagnetic sensor 110 includes a driving signal producing unit 111, X, Y and Z-axis flux-gates 112, a signal processing unit 113, and a geomagnetic sensor control unit 114. The driving signal producing unit 111 produces signals to drive the X, Y and Z-axis flux-gates 112. In an embodiment, the driving signals may be provided in the shape of a pulse, or a reverse pulse.

The X, Y and Z-axis flux-gates 112 are made up of three cores perpendicular to one another, and coils to wind the cores. Accordingly, when the driving signals are transferred to the coils, the coils are excited to produce output values corresponding to a peripheral magnetism.

The signal processing unit 113 carries out various processes, such as amplifying, analog/digital (A/D) conversion, etc., to the output values output from the X, Y and Z-axis flux-gates 112, and then provides them to the geomagnetic sensor control unit 114.

The geomagnetic sensor control unit 114 may, thus, normalize the output values output from the signal processing unit 113 using the predetermined offset value and the predetermined scale value, and then outputs them to the outside. The normalization process can be carried out through the following equation 10, for example.

$$\text{Equation 10:} \\ {Xf}_{norm} = \frac{( Xf - {Xf}_{bias} )}{{Xf}_{sf}} * α , {Yf}_{norm} = \frac{( Yf - {Yf}_{bias} )}{{Yf}_{sf}} * α , {Zf}_{norm} = \frac{( Zf - {Zf}_{bias} )}{{Zf}_{sf}} * α \\ {Xf}_{offset} = \frac{( {Xf}_{max} + {Xf}_{min} )}{2} , {Yf}_{offset} = \frac{( {Yf}_{max} + {Yf}_{min} )}{2} , {Zf}_{offset} = \frac{( {Zf}_{max} + {Zf}_{min} )}{2} \\ {Xf}_{sf} = \frac{( {Xf}_{max} - {Xf}_{min} )}{2} , {Yf}_{sf} = \frac{( {Yf}_{max} - {Yf}_{min} )}{2} , {Zf}_{sf} = \frac{( {Zf}_{max} - {Zf}_{min} )}{2} \qquad$$

Here, Xf, Yf, and Zf are three-axis output values of the signal processing unit 113, respectively, Xfₙₒᵣₘ, Yfₙₒᵣₘ, and Zfₙₒᵣₘ are three axis normalized values, respectively, Xfₘₐₓ and Xfₘᵢₙ are a maximum value and a minimum value of Xf, respectively, Yfₘₐₓ and Yfₘᵢₙ are a maximum value and a minimum value of Yf, respectively, Zfₘₐₓ and Zfₘᵢₙ are a maximum value and a minimum value of Zf, respectively, and α is a fixed constant.

In this case, α uses a value less than 1, so that the output values of the signal processing unit 113 can be mapped in values within the range of ±1 in a horizontal state. Preferably, but not necessarily, α can be set by using a typical magnetic dip value of the area in which the azimuth measuring apparatus, i.e., the three-axis geomagnetic sensor, is used. In South Korea, since the magnetic dip is about 53°, α can be set in cos 53≈0.6. Xfₘₐₓ, Xfₘᵢₙ, Yfₘₐₓ, Yfₘᵢₙ, Zfₘₐₓ, and Zfₘᵢₙ are set in a manner that in advance, measures output values from the three-axis geomagnetic sensor while rotating the three-axis geomagnetic sensor at least one time, and then selects maximum values and minimum values among the measured output values. The set values of α, Xfₘₐₓ, Xfₘᵢₙ, Yfₘₐₓ, Yfₘᵢₙ, Zfₘₐₓ, and Zfₘᵢₙ can be stored in a memory (not illustrated) disposed in the three axis geomagnetic sensor 110, or the external first storing unit 180, so that they can be used in the normalization process.

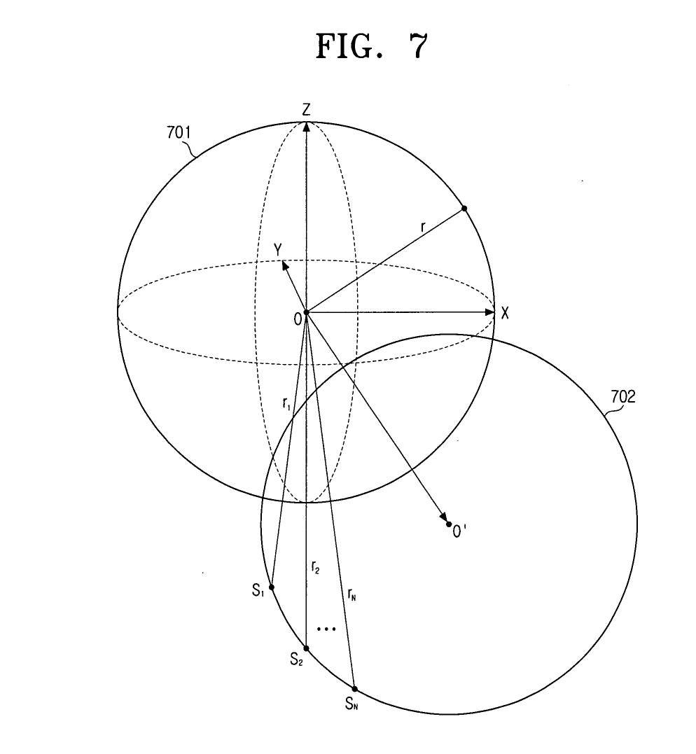

FIG. 6 illustrates an example of an orientation of the three-axis flux-gates in the electronic devices 100, for example. Referring to FIG. 6, in the three axis geomagnetic sensor 110, the X-axis flux-gate may be arranged in a direction to direct a front end of the electronic device 100, and the Y-axis flux-gate arranged in a direction to direct a lateral side of the electronic device 100. The X-axis flux-gate and the Y-axis flux-gate are arranged to be perpendicular to each other in a plane on which the electronic device 100 is placed. The Z-axis flux-gate may, thus, be arranged to be vertical to the plane on which the electronic device 100 is placed.

FIG. 7 illustrates a spherical coordinate system in which output values of the three-axis geomagnetic sensor 110 are distorted under the influence of peripheral magnetism and an offset value corrected using the output values are indicated. Referring to FIG. 7, a predetermined offset value is represented as O. Output values of the three-axis geomagnetic sensor 110 measured under a state in which there is no geomagnetic distortion are positioned on a spherical surface of a first sphere 701 centering on O. However, if there is a geomagnetic distortion, output values of the three-axis geomagnetic sensor 110 deviate from the spherical surface of the first sphere 701. Accordingly, it is possible to easily detect whether there is geomagnetic distortion by calculating distances between the output values of the three-axis geomagnetic sensor 110 and the offset value and then comparing the calculated distances with a radius value r. Alternatively, the radius value r can be set to have a tolerance of ±a %. In this case, when the calculated distances exceeds the radius value r±a %, it is determined that there is geomagnetic distortion.

On the other hand, the values, which are sampled when it is first determined that the offset value is distorted, are represented as S1, S2 . . . SN. Accordingly, it is possible to secondly determine whether the offset value is distorted with calculating distances r1, r2 . . . rN between the output values S1, S2, . . . SN and the offset value and then comparing a mean value and a standard deviation value to the calculated distances r1, r2 . . . rN with permissible ranges, respectively. The permissible range to the mean value can be set in the same range as that of the radius value. FIG. 7 illustrates a case in which the distances r1, r2 . . . rN are gradually increased, thereby deviating the mean value and the standard deviation value from the permissible ranges, respectively. Accordingly, if the correcting operation is carried out, the offset value is corrected as a new offset value O′, that is, a center of a second sphere 702 having a spherical surface on which the plurality of sampled values S1 SN are placed.

Accordingly, the normalization process may be carried out using the corrected offset value, so that the influence generated as a result of the geomagnetic distortion can be prevented.

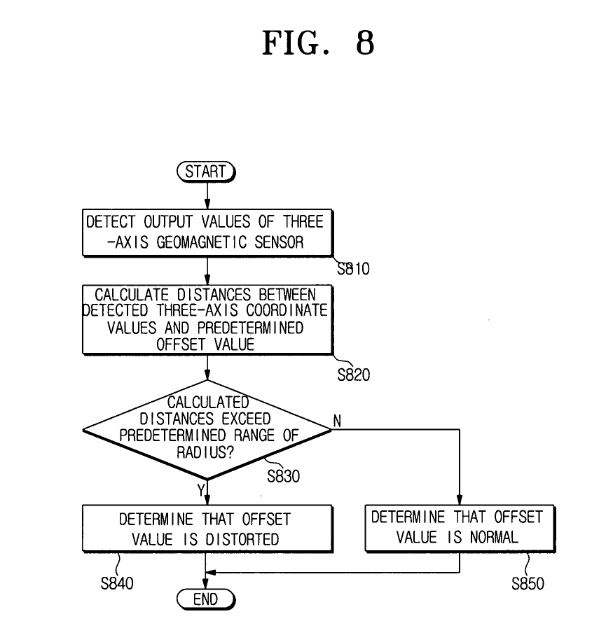

FIG. 8 illustrates an error check method of an electronic device, according to an embodiment of the present invention.

Referring to FIG. 8, when output values are detected from the three-axis geomagnetic sensor 110 (in operation S810), distances between the three-axis coordinate values of the detected output values and the predetermined offset value may be calculated (in operation S820). The distance calculations can be carried out using the above equation 1.

Subsequently, the calculated distances may be compared with a predetermined range of radius values (in operation S830). As a result of the comparison, if the calculated distances exceed the predetermined range of radius values (S830:Y), it may be determined that the offset value is distorted (in operation S840).

To the contrary, if the calculated distances are determined to bewithin the predetermined range of radius values (in operation S830), it may be further determined that the offset value is normal (in operation S850). An electronic device using the error check method of FIG. 8 may periodically and repeatedly carry out operation S810 through S830 described above, so that it can periodically check whether there is an error.

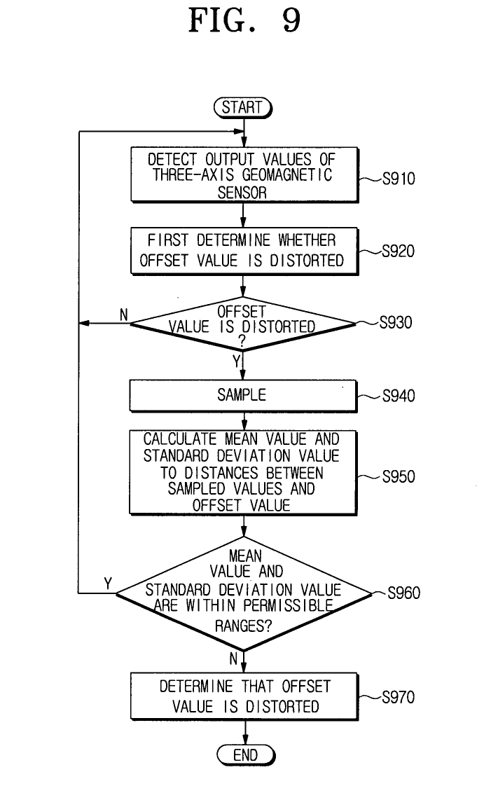

FIG. 9 illustrates an error check method of an electronic device, according to another embodiment of the present invention. In the error check method of FIG. 9, operation S910 of detecting output values from the three-axis geomagnetic sensor 110 and operation S920 of first determining whether an offset value is distorted are similar to of the error check method of FIG. 8, thus descriptions thereof will be omitted for clarity and conciseness.

As a result of the first determination, if it is determined that the offset value is distorted (in operation S930), a sampling operation is carried out for a predetermined time. At this time, preferably, but not necessarily, the sampling operation may be carried out to selectively sample values, so that each of the distances between the sampled values comes to be above a predetermined distance. Since the sampling operation has been described in detail above, further descriptions thereof are omitted for clarity and conciseness.

After that, the distances between the sampled values and the offset value may be calculated, and a mean value and a standard deviation value for the calculated distances calculated (in operation S950). Subsequently, it may be determined whether the calculated mean value and the calculated standard deviation value are within the permissible ranges, respectively (in operation S960). If they are within the permissible ranges (in operation S960), it is determined that the offset value is normal. Operations S910 through S960 described above may periodically and repeatedly be carried out so that detection of errors can occur periodically.

On the other hand, in the sampling operation, if it is determined that the calculated distances between the sampled values and the offset value are within the predetermined range of radius values, the sampling operation may be stopped, and the process is returned to operation S910 to again carry out operations after operation S910. This is to accommodate transient distortion in which the electronic device 100 can be placed under geomagnetic distortion environment for a while, and then returned to a normal environment, caused for example by movement of a user. Accordingly, if the electronic device 100 is returned to a normal environment while carrying out the sampling operation, it may preferably stop the sampling operation, and recognize the present offset value as being normal.

In this embodiment, the electronic device 100 stops the sampling operation only when the calculated distance falls within the predetermined range of radius values continuously, or more than a predetermined threshold, for example, three times.

At operation 960, if the calculated mean value and the calculated standard deviation value exceed the permissible ranges, it is determined that the offset value is distorted (in operation S970).

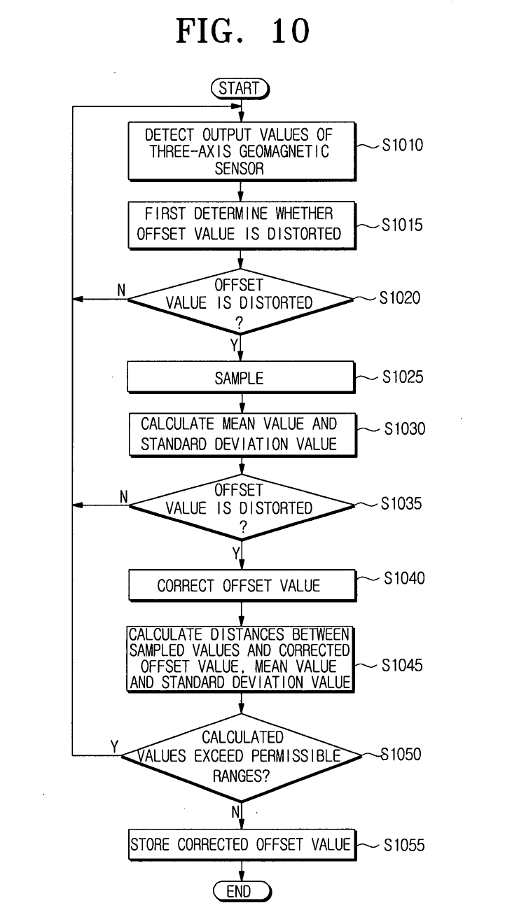

FIG. 10 illustrates an error check method of an electronic device, according to still another embodiment of the present invention. Referring to FIG. 10, a two-step determination is made whether an offset value is distorted using output values of the three-geomagnetic sensors (S110-S1035). Since the operations of operations S1010 through S1035 are similar to those of the error check method of FIG. 9, descriptions thereof are omitted for clarity and conciseness.

If, as a result of the second determination, it is determined that the offset value is distorted (in operation S1035), a correcting operation for correcting an offset value is carried out (in operation S1040). The correcting operation can be carried out using various methods as described above. Alternatively, instead of automatically correcting the offset value, a message may be output to inform the user that the geomagnetism is distorted, thereby allowing the user to take appropriate measures.

After the correcting operation is completed, distances between the corrected offset value and the sampled values are calculated, and a mean value and a standard deviation value for the calculated distances may be calculated (in operation S1045). Subsequently, it is determined whether the corrected offset value is distorted using the calculated values (in operation S1050). Then, the distortion determination of the offset value can be carried out twice as described above, or only once using the mean value and the standard deviation value.

As a result of the distortion determination, if it is determined that the offset value is distorted, the process is returned to operation 1010 to again repeat the operations of determining whether the offset value is distorted and to correct the offset value. Alternatively, a message may be output to inform the user that the geomagnetism is distorted, thereby allowing the user to forcibly reset the electronic device 100 or to take other appropriate measures.

To the contrary, in operation S1050, if the calculated values are within the permissible ranges (in operation S1050), the corrected offset value is stored for use in the normalization process (in operation S1055). Accordingly, the azimuth angle can be calculated using the output values of the three-axis geomagnetic sensor 110 normalized according to the corrected offset value, allowing enhanced accuracy.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

As apparent from the foregoing description, according to embodiments of the present invention, distances between the geomagnetic output values and the offset value may be confirmed to determine whether the offset value is distorted, thereby allowing distortion to be quickly discovered. In addition, if it is first determined that the offset value is distorted, the plurality of values may be sampled from the geomagnetic output values, and secondly determine whether the offset value is distorted using the sampled values, thereby allowing the error to be checked using a two-step determination for greater accuracy.

Also, according to an embodiment of the present invention, an error can be checked for and automatically corrected if it is determined that the error is generated. In addition, if the offset value is corrected after it is determined that the offset value is distorted, the electronic device and the error check method and medium thereof according to the exemplary embodiments of the present invention can determine whether the corrected offset value is the right value and inform the user of the determined result. Thus, an electronic device, method, and medium, according to an embodiment of the present invention, can quickly and accurately check whether the offset value is distorted, carry out the correction according to the checked result, and determine whether the corrected value is right, thereby allowing the user to easily produce an accurate azimuth angle. Accordingly, user convenience is maximized.

Although representative embodiments of the present invention have been shown and described in order to exemplify principles of the present invention, the present invention is not limited to the specific embodiments. It will be understood that various modifications and changes can be made by one skilled in the art without departing from the spirit and scope of the invention as defined by the appended claims. Therefore, it shall be considered that such modifications, changes and equivalents thereof are all included within the scope of the present invention.

What is claimed is:

1. An electronic device comprising:
a three-axis geomagnetic sensor;
a first calculating unit to calculate a distance between a geomagnetic output value generated by the three-axis geomagnetic sensor and an offset value; and
a controller to determine that the offset value is distorted when the distance calculated by the first calculating unit deviates from a predetermined range of radius values.

2. The electronic device of claim 1, further comprising:
a sampling unit to sample geomagnetic output values output from the three-axis geomagnetic sensor when the distance calculated by the first calculating unit deviates from the predetermined range of radius values; and
a second calculating unit to calculate a mean value and a standard deviation value to distances between the plurality of sampled values output from the sampling unit and the offset value,
wherein the controller finally determines that the offset value is distorted, when the mean value and the standard deviation value calculated by the second calculating unit deviate from predetermined permissible ranges, respectively.

3. The electronic device of claim 2, further comprising a correcting unit to correct the offset value when the controller determine that the offset value is distorted.

4. The electronic device of claim 3, wherein the correcting unit corrects the offset value by applying a least square fitting method of using the plurality of sampled values.

5. The electronic device of claim 3, wherein when the offset value is corrected by the correcting unit, the controller controls the first and the second calculating units to calculate a mean value and a standard deviation value to distances between the plurality of sampled values and the corrected offset value, and then compares the calculated mean value and the calculated standard deviation value with the predetermined permissible ranges, respectively, to determine whether the corrected offset value is distorted.

6. The electronic device of claim 1, further comprising a displaying unit to display a message that indicates that the offset value is distorted when the control unit determines that the offset value is distorted.

7. The electronic device of claim 2, wherein, when one geomagnetic output value is sampled from the three-axis geomagnetic sensor, the sampling unit confirms a distance of the sampled one geomagnetic output value to previously sampled geomagnetic output values, and selects the sampled one geomagnetic output value as a sampling value only when the confirmed distance is above a predetermined distance.

8. The electronic device of claim 2, further comprising:
a first storing unit to store information on the offset value, the predetermined range of radius values, and the predetermined permissible ranges for the mean value and the standard deviation value; and
a second storing unit to store the plurality of sampled values sampled by the sampling unit.

9. The electronic device of claim 2, wherein the distances, the mean value and the standard deviation value are calculated using the following equations, respectively:
$$r ( i ) = \sqrt{{( {X}_{i} - Xo )}^{2} + {( {Y}_{i} - Yo )}^{2} + {( {Z}_{i} - Zo )}^{2}}$$
$$Mean = {\sum }_{i = 1}^{N} \frac{r ( i )}{N}$$
$$SD = {\sum }_{i = 1}^{N} \frac{{( r ( i ) - Mean )}^{2}}{N}$$
wherein (Xo, Yo, Zo) is a three-axis coordinate value of the offset value, (Xᵢ, Yᵢ, Zᵢ) is a three-axis coordinate value of an output value output at the i-th place from the three-axis geomagnetic sensor, r(i) is a distance between i-th three-axis output value and the offset value, Mean is the mean value, SD is the standard deviation value, i is a natural number and N is a number of samplings.

10. The electronic device of claim 3, wherein the three-axis geomagnetic sensor comprises:
X, Y and Z-axis flux-gates disposed orthogonally;
a driving signal producing unit to provide driving signals to the X, Y and Z-axis flux-gates;
a signal processing unit to operate, so that when the X, Y and Z-axis flux-gates are driven by the driving signals to output electric signals corresponding to a peripheral magnetism, the signal processing unit converts the output electric signals into digital values and outputs the converted digital values; and
a geomagnetic sensor control unit to carry out a normalization operation to map the output digital values from the signal processing unit into values within a predetermined magnitude by using the corrected offset value and a predetermined scale value and to output respective normalized three-axis output values.

11. The electronic device of claim 10, further comprising:
an inclined angle calculating unit to calculate a pitch angle and a roll angle of the electronic device,
wherein the controller calculates an azimuth angle using the normalized three-axis output values, the pitch angle and the roll angle when the three-axis output values normalized by the offset value and the predetermined scale value is provided from the geomagnetic sensor control unit.

12. An error check method of an electronic device using a three-axis geomagnetic sensor comprising:
calculating a distance between a geomagnetic output value output from the three-axis geomagnetic sensor and an offset value; and
determining that the offset value is distorted when the calculated distance deviates from a predetermined range of radius values.

13. The method of claim 12, further comprising:
sampling a plurality of values among geomagnetic output values output from the three-axis geomagnetic sensor when the calculated distance deviates from the predetermined range of radius values;
calculating a mean value and a standard deviation value to distances between the plurality of sampled values and the offset value; and
finally determining that the offset value is distorted when the calculated mean value and the calculated standard deviation value deviate from predetermined permissible ranges, respectively.

14. The method of claim 13, further comprising correcting the offset value when the offset value is determined as distorted.

15. The method of claim 14, wherein the correcting the offset value comprises
correcting the offset value by applying a least square fitting method of using the plurality of sampled values.

16. The method of claim 14, further comprising:
recalculating a mean value and a standard deviation value to distances between the plurality of sampled values and the corrected offset value;
comparing the recalculated mean value and the recalculated standard deviation value with the predetermined permissible ranges, respectively, to determine whether the corrected offset value is distorted; and
repeatedly carrying out the operations from the calculating the distance through the finally determining that the offset value is distorted, when the corrected offset value is determined as distorted.

17. The method of claim 12, further comprising displaying a message, which
informs that the offset value is distorted, when the offset value is determined as distorted.

18. The method of claim 14, wherein the sampling the plurality of values comprises confirming a distance of one geomagnetic output value to the geomagnetic output values sampled in advance when the one geomagnetic output value is sampled from the three-axis geomagnetic sensor, and selecting the sampled one geomagnetic output value as a sampling value only when the confirmed distance is above a predetermined distance.

19. The method of claim 13, wherein the distances, the mean value and the standard deviation value are calculated using the following equations, respectively:
$$r ( i ) = \sqrt{{( {X}_{i} - Xo )}^{2} + {( {Y}_{i} - Yo )}^{2} + {( {Z}_{i} - Zo )}^{2}}$$
$$Mean = {\sum }_{i = 1}^{N} \frac{r ( i )}{N}$$
$$SD = {\sum }_{i = 1}^{N} \frac{{( r ( i ) - Mean )}^{2}}{N}$$
wherein (Xo, Yo, Zo) is a three-axis coordinate value of the offset value, (Xᵢ, Yᵢ, Zᵢ) is a three-axis coordinate value of an output value output at the i-th place from the three-axis geomagnetic sensor, r(i) is a distance between the i-th three-axis output value and the offset value, Mean is the mean value, SD is the standard deviation value, i is a natural number and N is the number of sampling.

20. The method of claim 13, wherein the sampling the plurality of values comprises
terminating the sampling when a situation where the distance between the geomagnetic output value and the predetermined offset value calculated during the sampling is within the predetermined range of radius values occurs more than predetermined number.

21. At least one medium comprising computer readable code to control at least one processing element to implement an error check method of an electronic device using a three-axis geomagnetic sensor, the method comprising:
calculating a distance between a geomagnetic output value output from the three-axis geomagnetic sensor and an offset value; and
determining that the offset value is distorted when the calculated distance deviates from a predetermined range of radius values.
